(19) United States
(12) Patent Application Publication
(10) Pub. No.: US 2012/0307039 A1
(43) Pub. Date: Dec. 6, 2012

(54) Apparatus for Providing a View of an Area that is Hard to Reach or Inaccessible

(76) Inventor: Simon Peter Holmes, Gloucestershire (GB)

(21) Appl. No.: 13/578,911

(22) PCT Filed: Feb. 15, 2011
(86) PCT No.: PCT/IB11/00709

§ 371 Date: Aug. 14, 2012

(30) Foreign Application Priority Data
Feb. 15, 2010 (GB) 1002544.3

(51) Int. Cl. H04N 7/18

(52) U.S. Cl. 348/82; 348/E07.085

(57) ABSTRACT

An apparatus for use in providing a view of an area is provided. The apparatus has a handle that can be gasped by a user and a screen for displaying a live image. Control members are present and are used to make selections. A freeze image is present and is capable of being displayed on the screen. Actuation of a single one of the control members causes the screen to toggle between the live image and the freeze image.

### CROSS REFERENCE TO RELATED APPLICATIONS

This application claims the benefit of and priority to GB Application Serial Number 1002544.3 filed on Feb. 15, 2010 whose inventor is Simon Peter Holmes and entitled, “Apparatus for Providing a View of an Area that is Hard to Reach or Inaccessible.” The entire contents of GB Application Serial Number 1002544.3 are incorporated by reference herein in their entirety for all purposes.

### FIELD OF THE INVENTION

The present invention relates generally to an apparatus for providing a view of an area is hard to access. More particularly, the present application involves a boroscope with a control means that can be held in, and actuated by, one hand of the user.

### BACKGROUND

One type of known apparatus that affords a view of an area that is hard to reach or inaccessible includes a miniature video camera mounted on an end of an inspection cable. The inspection cable has a screen at its end remote from the video camera. The screen receives images from the video camera so that a user can see what the camera is seeing at the viewing area. Images from the camera to the screen are often transmitted using fiber optic technology. The apparatus may be known as a boroscope or an endoscope. There are number of different types of devices. All of the known types are cumbersome, and use box-type control means requiring two-handed operation. Generally the known types of boroscopes are not ergonomically designed and are difficult to use. Further, these types of devices lack certain features that a user may find useful in accomplishing inspections and comparisons. As such, there remains room for variation and improvement in the art.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended Figs. in which:

FIG. 1 is a perspective view of an apparatus for providing a view in accordance with one exemplary embodiment.

FIG. 2 is a perspective view of the apparatus of FIG. 1 shown from underneath the apparatus.

FIG. 3 is a front view of the apparatus of FIG. 1.

FIG. 4 is a back view of the apparatus of FIG. 1.

FIG. 5 is a right side view of the apparatus of FIG. 1.

FIG. 6 is a left side view of the apparatus of FIG. 1.

FIG. 7 is a top view of the apparatus of FIG. 1.

FIG. 8 is a bottom view of the apparatus of FIG. 1.

FIG. 9 is a perspective view of an apparatus that has a C-shaped handle in accordance with another exemplary embodiment.

FIG. 10 is a right side view of an apparatus that has a bent handle in accordance with another exemplary embodiment.

FIG. 11 is a screenshot of a primary display.

FIG. 12 is a screenshot of a freeze photograph.

FIG. 13 is a screenshot of a live view toggled from freeze.

FIG. 14 is a screenshot of a secondary display.

FIG. 15 is a screenshot of a playback screen.

FIG. 16 is a screenshot of a project folder screen.

FIG. 17 is a screenshot of a photograph screen.

FIG. 18 is a screenshot of a saved photograph screen.

FIG. 19 is a screenshot of an edit screen.

FIG. 20 is a screenshot of a configuration menu screen.

FIG. 21 is a screenshot of a display screen.

FIG. 22 is a screenshot of a photo menu screen.

FIG. 23 is a screenshot of a brightness selection screen.

FIG. 24 is a screenshot of a color selection screen.

FIG. 25 is a screenshot of a zoom screen.

FIG. 26 is a screenshot of a pan screen.

FIG. 27 is a screenshot of the pan screen of FIG. 26 after actuation of the mode soft key.

Repeat use of reference characters in the present specification and drawings is intended to represent the same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

The present invention provides for an apparatus 2 capable of being used as a boroscope to view objects from inaccessible or inconvenient locations. The apparatus may include a control means 6 and a handle 16 that can be held by a single hand 30 of the user. The user may actuate the control means 6 with the same hand he or she is using to hold the handle 16 so that the other hand of the user can be free to position a video camera 4 or perform some other task. The apparatus can be configured so that a toggle feature is available to the user to allow the user to switch a display on a screen 26 from a first display to a second display and then back. Such toggle feature may be effected by the actuation of but a single control member such as a wheel 20 that can be turned forward and backward to switch between displays.

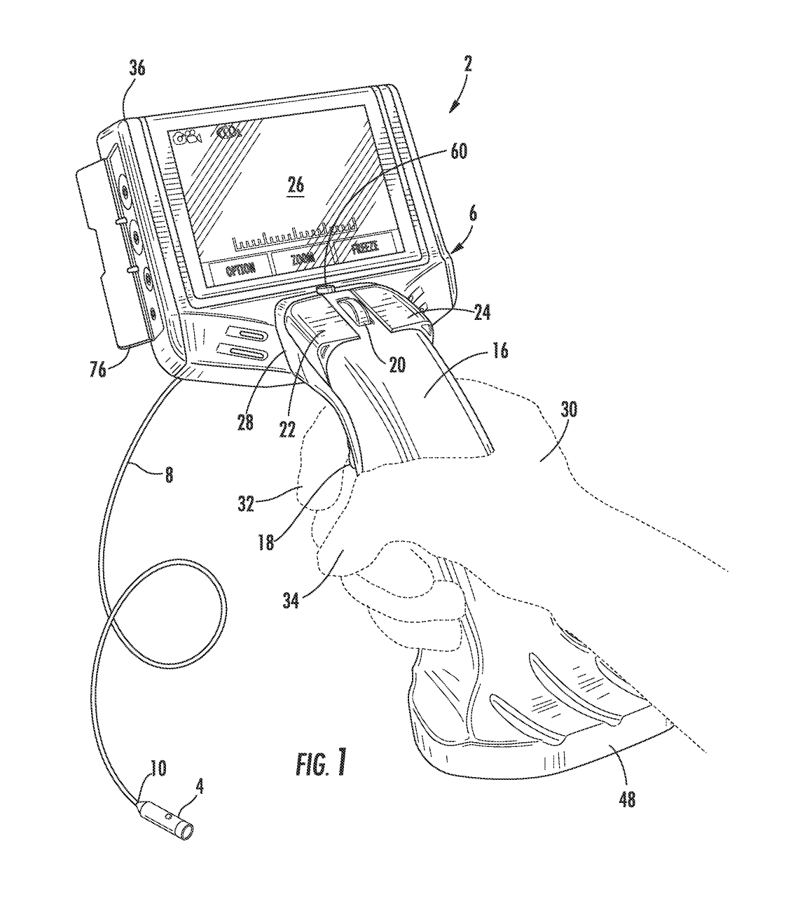

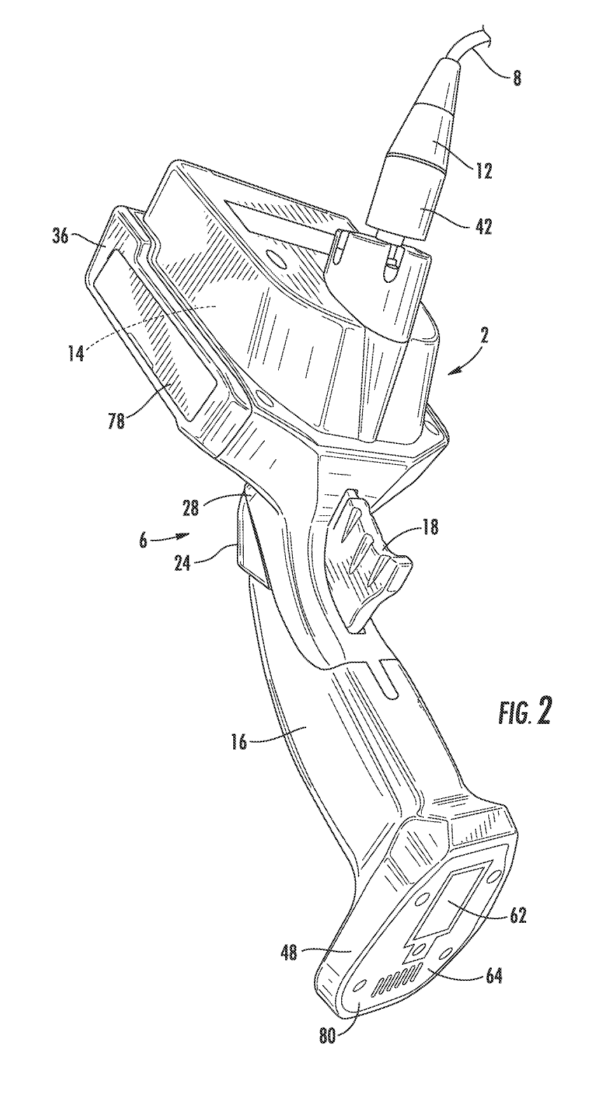

With reference now to FIGS. 1-8, there is shown an apparatus 2 for providing a view of an area that is hard to reach or inaccessible. The apparatus 2 has a video camera 4 for viewing the area, control means 6 for the video camera 4, and a cable 8 which is connected at a first end 10 to the video camera 4, and at a second end 12 to the control means 6. The cable 8 transmits images from the video camera 4 to the control means 6. The cable 8 may be flexible, rigid, semi-rigid, or supported on a rigid support. The video camera 4 may be a miniature video camera 4, and the cable 8 can be a fiber optic cable 8. In other arrangements, the cable 8 need not be a fiber optic cable but can be an electrical cable or any other type of cable. Further, in yet other arrangements, the cable 8 need not be present and the video camera 4 can transmit wirelessly. The cable 8 can be of a diameter that is 14 mm, 10 mm, 5 mm or from 2-20 mm. The cable 8 may have a length that is 1 m, 2 m, 4 m, 5 m, or up to 10 m, and can be water and solvent proof. The control means 6 includes memory means 14 enabling the apparatus 2 to perform different functions. The memory means 14 may include a central processing unit in certain arrangements and can have a random access memory and/or a solid state memory in other embodiments.

The control means 6 can also include a handle 16, control members 18, 20, 22, 24, and a screen 26 on which the images from the video camera 4 are received. The control members 18, 20, 22, 24 are positioned on a part 28 of the handle 16 which is adjacent the screen 26 so that a user is able to hold the apparatus 2 in one hand 30 and operate the control members 18, 20, 22, 24 with the same hand 30. The apparatus 2 is ergonomically designed and does not cause the user's hand 30 to become tired during operation of the apparatus 2. By allowing the apparatus 2 to be used with one hand, user frustration is also avoided because the other hand of the user may be completely free to help accomplish the task in question. The handle 16 may be a pistol-grip handle with a base part 48 which supports the hand 30 as shown. The bottom of the hand 30 of the user may rest on the base part 48 when grasping. The handle 16, including the base part 48, may be made of a soft rubber for added comfort during use.

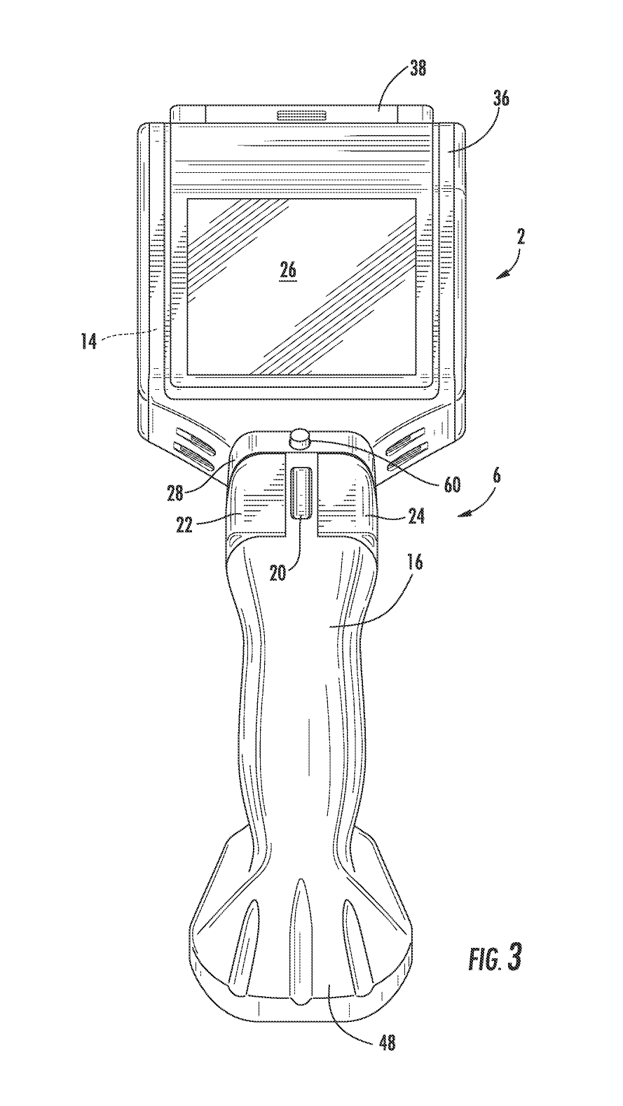

The control member 18 may be a trigger 18, the control member 20 may be a wheel 20, the control member 22 may be a first key 22, and the control member 24 may be a second key 24. The first key 22 and the second key 24 may be used to actuate soft keys. The first and second keys 22 and 24 can be actuated by the thumb 34 of the user. The wheel 20 can be rotated in a forward direction towards the screen 26 or in a rearward direction away from the screen 26. The wheel 20 may be rotated 360 degrees in some arrangements or its degree of rotation can be limited in yet other arrangements. The trigger 18 is on an underside of the handle 16 and is thus on an opposite side of the handle 16 from the keys 22 and 24 and wheel 20. The wheel 20, the first key 22 and the second key 24 are on an upper side of the handle 16. The trigger 18 can be operated by a forefinger 32 of the hand 30, while the wheel 20, the first key 22 and the second key 24 are able to be operated by the thumb 34 of the hand 30. The wheel 20 is positioned between the first key 22 and the second key 24. As shown with reference to FIG. 3, the first key 22 is on the left side of the wheel 20 and the second key 24 is on the right of the wheel 20. A power button 60 can be located between the screen 26 and the control members 20, 22 and 24. Specifically, the power button 60 can be located directly between the screen 26 and the wheel 20. The user can press the power button 60 in order to turn the memory means 14 on and off so as to turn the apparatus 2 on and off as desired. As with the wheel 20, first key 22, and second key 24, the power button 60 may be actuated by the thumb 34 of the user without the user having to move his or her hand 30 off of the handle 16.

During operation of the apparatus 2, the wheel 20 may be employed to control zoom, menu choices, and the setting of variables within the apparatus 2. The first key 22 may be used for entering or exiting in operating mode. The second key 24 may be used as a function key which provides context sensitive choices afforded by the memory means 14. The trigger 18 can be used for starting and stopping recording and/or selecting a highlighted menu option.

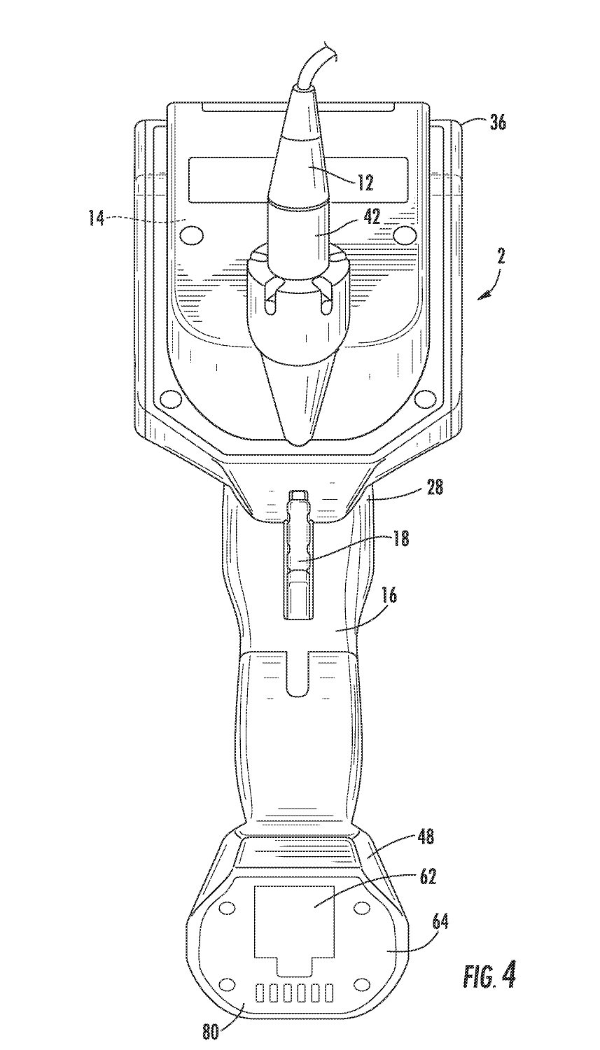

The screen 26 is on a head part 36 of the apparatus 2. The screen 26 can be a 3.5 inch LCD screen and can deliver crystal clear images and bright easy-to-read menu options. The screen 26 may be a 2.5 inch LCD screen in other arrangements. The screen 26 may display color or grayscale as desired. The head part 36 of the apparatus 2 can include a plurality of connectors for providing connection to other devices. With reference now to FIG. 5, a door 78 on the head part 36 can be opened to reveal a connector 40 for a SD card slot for allowing expansion of memory 14 for more recordings. In this regard additional photos or video can be stored on an SD card inserted into the SD card slot 40. A power cord input 66 can also be provided for receiving an end of a power cable cord. The power cord input 66 can be marked as 5 volts in and the apparatus 2 may be driven by the connected power cord. A USB port connector 46 may be provided for enabling rapid transfer of recordings to a computer, direct view and record with a personal computer, software upgrades, or other functionality as desired. The photos and video from the apparatus 2 can be copied to the PC so that the individual project folders are likewise copied with the photos and video therein and thus organized directly on the PC. The apparatus 2 may include one or more ports for the attachment of additional modules to increase functionality of the device. An optional wireless adaptor with a secondary wireless screen for remote viewing can be used so that images captured by the video camera 4 can be sent to one or more other stations for enhanced monitoring. In this regard, the feed from the video camera 4 can be viewed on multiple machines to allow more people to work on the particular project.

With reference now to FIG. 6, a door 76 of the head part 36 can be opened to reveal additional connections. An AV out port 68 may be present into which a line can be attached so that audio and visual output from the apparatus 2 can be transferred to a television, computer, or other device. An AV in port 70 may be present and can be connected to a line so that audio and visual input may be sent to the apparatus 2 and can be displayed on the screen 26. In certain embodiments, the AV in port 70 can have a microphone attached thereto for adding narrative during video recordings. A DC out port 72 may also be provided for use in supplying direct current from the apparatus 2. For example, it may be the case that a wireless module is included to allow for an additional screen to be present so that more than one user can view the images captured by the video camera 4. The wireless module can be powered by the DC out port 72 and transmit information wirelessly to a receiving unit at a remote location for viewing or download. The wireless module may be connected to the AV in port 70 and/or the AV out port 68 for this functionality as well. Still further, a reset button 74 can be included and may be actuated by a user in order to return the apparatus to an initial, factory preset condition.

A multifunctional connector 42 is also included that allows the apparatus 2 to be connected to a variety of devices. As shown, the multifunctional connector 42 is connected to the second end 12 of the cable 8. The second end 12 can be detached from the multifunctional connector 42 and a different device may then be subsequently attached to the multifunctional connector 42. The multi-functional connector 42 may provide connection to a choice of different video cameras 4.

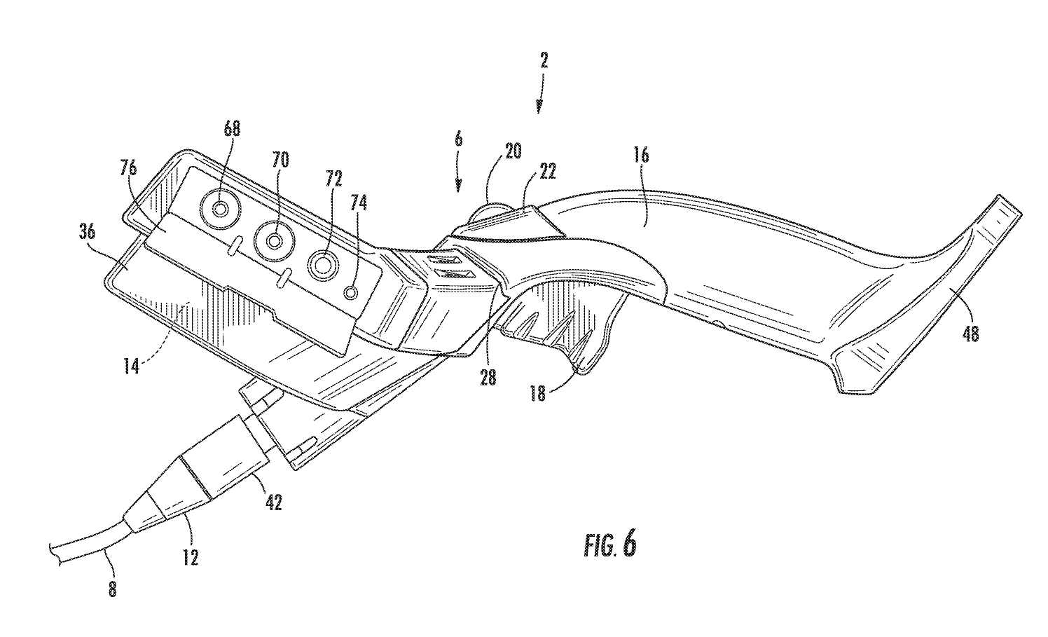

Although not shown, an expansion port can be provided on the head part 36 or other portion of the apparatus 2 to be in communication with the memory means 14 to increase the functionality of the apparatus 2. With reference now to FIG. 8, a magnet 64 can be included in the base part 48 so that the apparatus can be “stood up” on a metal tray, work bench, vehicle frame, or other magnetically attracted surface. The user can position the apparatus 2 so that the magnet 64 holds the apparatus 2 in a desired location or position so that the apparatus 2 does not have to be constantly held.

Also included in the base part 48 is a primary battery 62 that functions to run the apparatus 2 when the power cord input 66 is not present. The primary battery 62 may be a high capacity lithium battery pack. In other arrangements, the primary battery 62 and/or back-up battery 38 if present can be standard AA batteries. When the power cord input 66 is attached, the apparatus 2 may be directly run by this attachment when turned on. When turned off, attachment to the power cord input 66 by a power line may function to charge the primary battery 62. Further, the primary battery 62 may be charged at times even when the attached power line is functioning to run the apparatus 2. A stud finder 80 may be optionally included in the base part 48 and can be used to locate studs in the walls and ceilings of a structure when they are hidden from view by drywall or other building components. The stud finder 80 may provide utility to tradesmen in avoiding studs during positioning of the video camera 4.

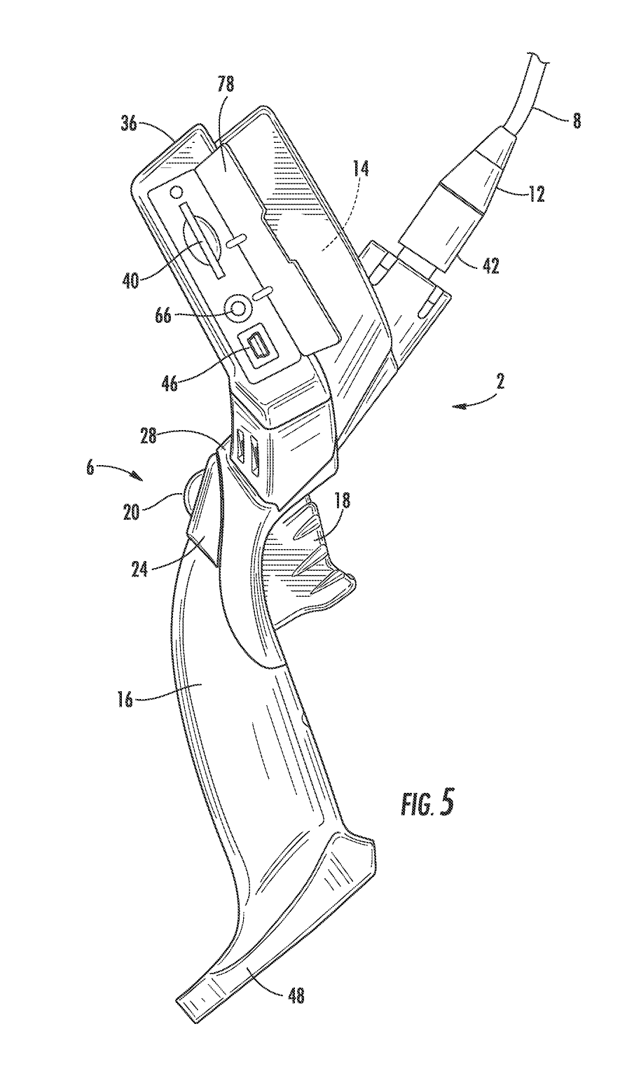

With reference now to FIG. 7, a slot for a back-up battery 38 in the head part 36 of the apparatus 2 is shown. The back-up battery 38 may be an optional feature when the apparatus 2 is to be used for extended periods of time away from a source of power. Once the charge in the primary battery 62 is used up, the apparatus 2 can switch over to the back-up battery 38 for power in order to allow the unit to continue to operate. The back-up battery 38 may be the same type of battery as the primary battery 62 or may be of a different type. The back-up battery 38 may be charged by a power source connected to the power cord input 66, or the back-up battery 38 may not be capable of being charged by the attached power line in other arrangements. In other exemplary embodiments, the back-up battery 38 may not be present but instead of this component an expansion port can be present in its place to allow for the addition of additional modules used to increase functionality of the apparatus 2. In yet other arrangements, a back-up battery 38 and an expansion port can be present on the head part 36.

The apparatus 2 can be configured differently from that illustrated in FIGS. 1-8. With reference to FIG. 9, the apparatus 2 can be configured so as to have a

C-shaped handle 16 that wraps around and extends to the head part 36. A smooth face plate 54 is formed at the head part 36 at the end of the handle 16 extension. A stud finder 80 can be located at the smooth face plate 54 to aid the user of the apparatus 2 in finding studs hidden behind a wall or ceiling. The smooth face plate 54 may be run over the area in question so as to allow the stud finder 80 to locate any studs present. Other items such as pipes and wires can be located with the stud finder 80. This information may make it easier for the user to drill a hole or holes in walls, ceilings or floors in order to feed the video camera 4 in by the cable 8. The apparatus 2 in FIG. 9 may be used by builders, plumbers and electricians for use in servicing, maintenance and inspection of buildings and other structures.

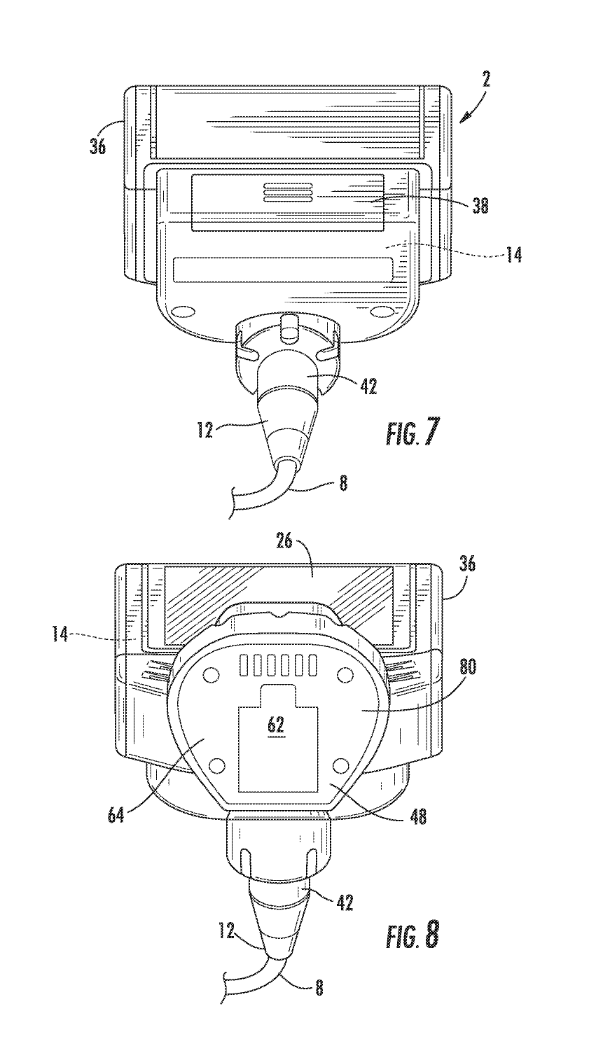

Turning now to FIG. 10, a third variation of the apparatus 2 is shown in which the handle 16 is elongated but bent and without the base part 48. As such, the apparatus 10 can be configured in several different ways and it is to be understood that the arrangements presented herein are only exemplary and that others are possible. The exemplary embodiments shown in FIGS. 9 and 10 can have additional features that are as those described with respect to the exemplary embodiment of FIGS. 1-8.

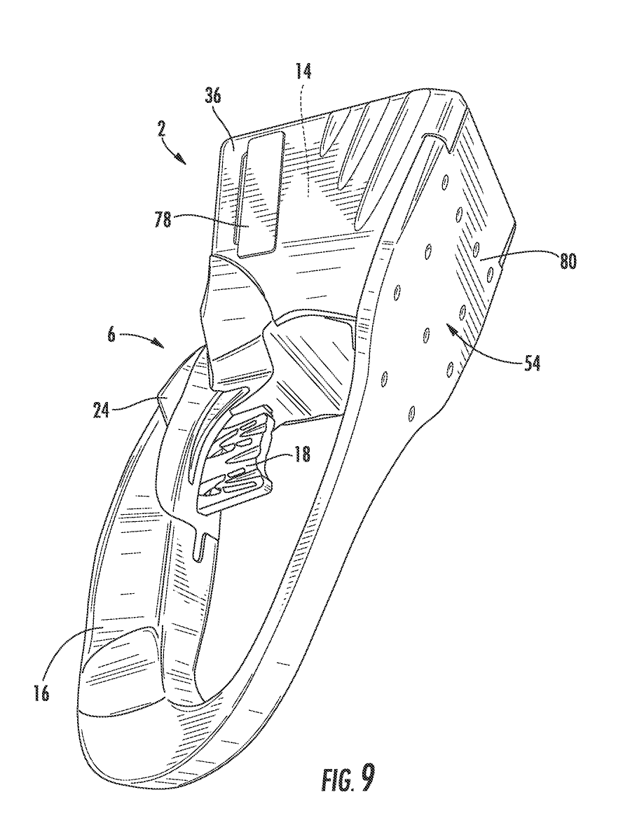

Operation of the device will now be explained. When a user grasps the handle 16 and presses the power button 60, the memory means 14 will begin its power up sequence and an introduction screen will be displayed to the user on screen 26. After the introduction screen, the primary display 82 will be presented to the user as illustrated, for example, in FIG. 11. The primary display 82 will show the view that the video camera 4 sees, in this case a stapler. It is to be understood that the use of a stapler as the item being viewed is only for sake of example, and that any item can be viewed by the apparatus 2. As such, the apparatus 2 is not limited for use as being viewed by a stapler or any other object in accordance with other exemplary embodiments.

Informational icons, such as battery life remaining, are displayed in the upper left corner of the primary display 82. The primary display 82 also has a primary display menu 84 at its bottom edge. The primary display menu 84 has three buttons that can be actuated by their respective control member 20, 22 or 24. For example, the option button can be actuated by pressing the first key 22 because the option button is on the left hand side of the primary display menu 84 and because the first key 22 is on the left hand side of the set of control members 20, 22 and 24. To further link the first key 22 to the option button, the first key 22 is located just below the option button. In a similar manner, the second key 24 controls the freeze button of the primary display menu 84 because both of these components are on the right hand side. Also, the second key 24 is located immediately below the freeze button to further link these two components.

A user turning the wheel 20 may actuate the zoom button of the primary display menu 84. The wheel 20 is located in the center of the control members 20, 22 and 24, and the zoom button is located in the center of all of the buttons of the primary display menu 84. Further, the wheel 20 is immediately below the zoom button. In use, a user can actuate one of the control members 20, 22 or 24 to cause the corresponding button of the primary display menu to be selected. Alternatively, the user may pull the trigger 18 in order to capture video or a picture. If the trigger 18 is pulled, the picture of the stapler as shown in FIG. 11 may be captured if the apparatus 2 is configured to take pictures instead of video.

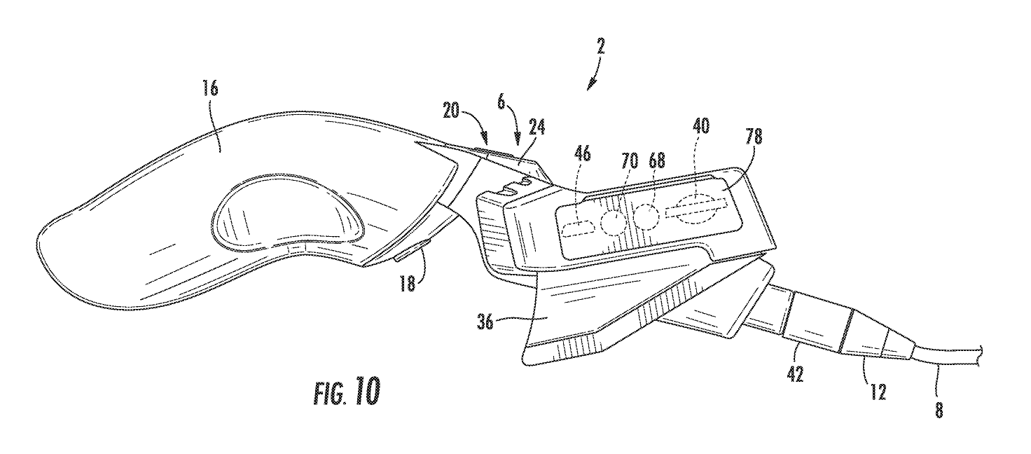

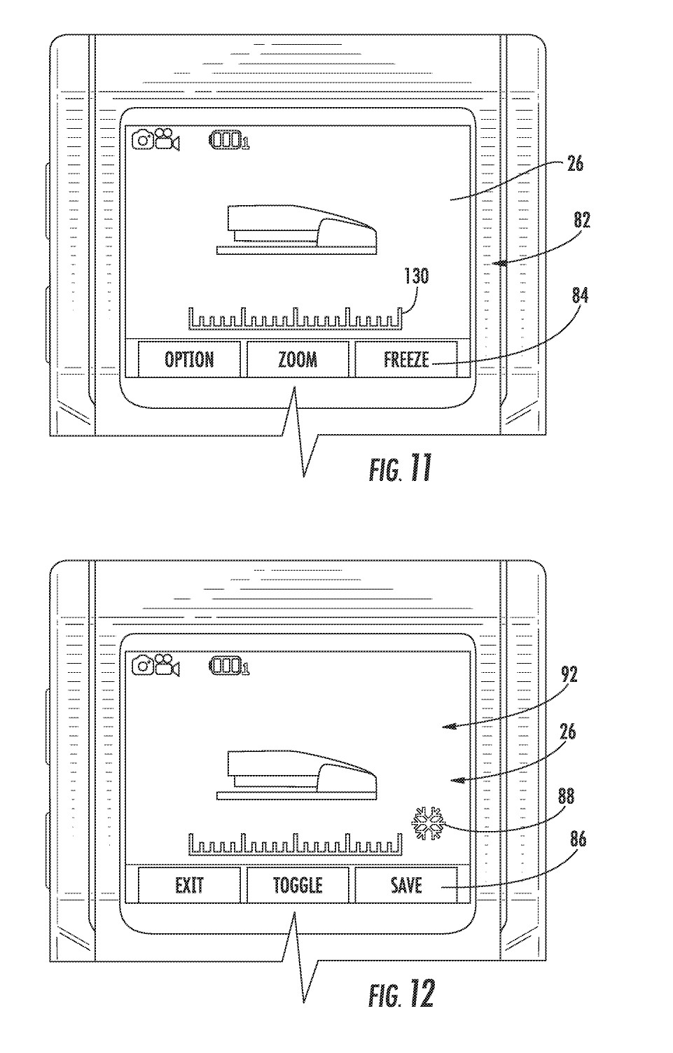

Hitting the second key 24 and causing the freeze key to be actuated will move the screen 26 to a freeze photograph 92 as shown in FIG. 12. Here, a freeze menu 86 will be presented to the user at the bottom of the screen 26 with an exit button, a toggle button, and a save button. Also, a freeze icon 88, here in the form of a snowflake, will be present on the screen 26. The freeze photograph 92 in FIG. 12 can be made so as to be a reference photograph. Actuation of the freeze key in the primary display 82 will cause the freeze photograph 92 to be taken of the image illustrated in the primary display 82. Alternatively, a photograph all ready stored on the apparatus 2 or transferred to the apparatus 2 can be designated as the freeze photograph 92. Although described as being a photograph, the freeze photograph 92 could be a video instead in other arrangements. The freeze photograph 92 may also be a paused frame of a video clip.

The freeze menu 86 has a save button that allows the user to a save the current freeze photograph 92 to memory. An exit button is also present on the freeze menu 86 and actuation of this button will cause the screen 26 to exit the freeze photograph 92 and freeze menu 86 and simply return to the primary display 82 of FIG. 11. The actuation of the exit, toggle, and save buttons may be the same as that previously described with respect to the buttons of the primary display menu 84 and a repeat of this information is not necessary. Additionally, the various buttons of additional menus that will be further discussed may be actuated in a manner similar to those previously discussed with respect to the control members 20, 22 and 24 and the primary display menu 84 and a repeat of this information is not necessary.

Once a freeze photograph 92 is in memory, the user may use this photograph as a reference photo to compare same to the actual photograph viewed by the video camera 4. From the freeze photograph 92, the user may turn the wheel 20 in order to actuate the toggle button on the freeze menu 86. This will cause the screen 26 to toggle to the live view toggled from freeze as shown in FIG. 13 that includes a live view toggled from freeze menu 90. Every time the user moves the wheel 20, the toggle button will be actuated. For example, each click or slight turn of the wheel 20 will cause the toggle button to actuate so that the screen 26 will turn back and forth between the live view in FIG. 13 and the freeze photograph in FIG. 12. The live view and the freeze photograph 92 can thus be switched back and forth upon simply turning the wheel 20 a slight amount such that no other control member needs to be actuated.

As shown in FIG. 13, the stapler is on its side. The views between FIGS. 12 and 13 can be compared with one another so that the user can determine the similarities and differences between the live view and the reference view as depicted in the freeze photograph 92. In practice, the user may be a mechanic who is viewing a belt on a vehicle that is hard to access or see. The belt as it should look in an undamaged state may be set at the freeze photograph 92, and the live view toggled from freeze can be the actual belt as seen on the vehicle in question. The mechanic can toggle back and forth between these two views in order to ascertain the differences and hence damage present on the belt in the live view.

From the live view toggled from freeze menu 90, the user can actuate the freeze button in order to override the freeze photograph 92 to cause the view seen in the live view toggled from freeze to now be the freeze photograph 92. The apparatus 2 can be set up so that there is at most only one freeze photograph 92 at one time. However, in other exemplary embodiments, the apparatus 2 can be arranged so that multiple freeze photographs 92 can exist. Also from the live view toggled from freeze menu 90 an exit button can be actuated in order to take the screen 26 out of this functionality and back to the primary display 82 illustrated in FIG. 11. Although described as being a toggle so that the freeze photograph 92 completely replaces the live view from the video camera 4, and vice versa, the apparatus 2 can be designed so that a split screen is presented that displays on the screen 26 at the same time the freeze photograph 92 and the live feed from the video camera 4. The split screen functionality may be used instead of the toggle feature, or may be used in addition to the toggle feature so that the apparatus 2 can utilize both means of comparison.

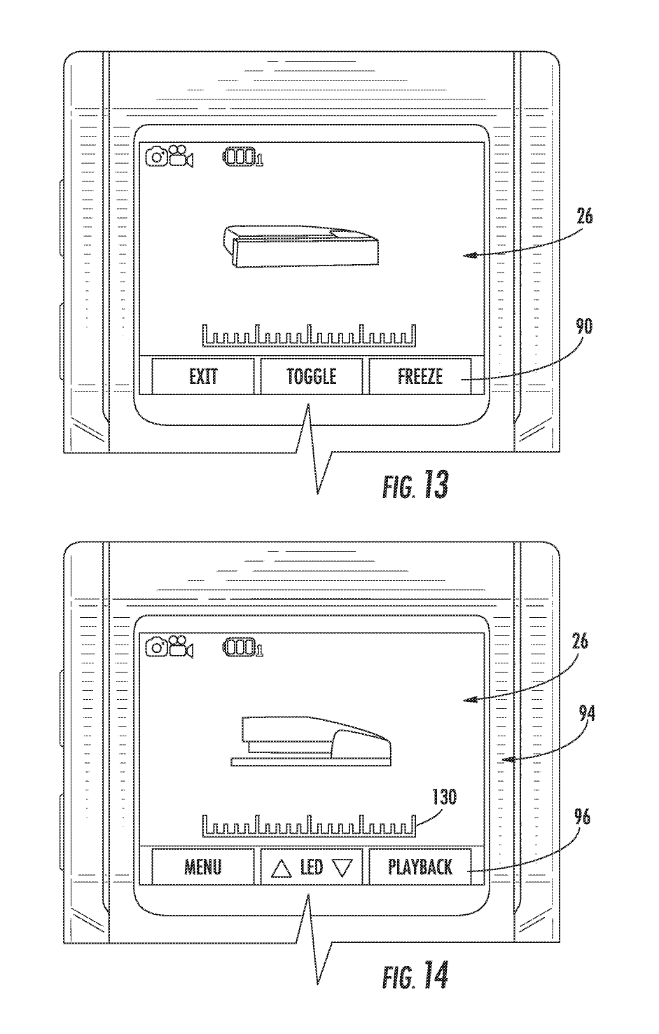

The primary display menu 84 of the primary display 82 has an option button on its left hand side that can be actuated in order to take the screen 26 to a secondary display 94 as illustrated in FIG. 14 that will still show the same view from the video camera 4 as in the primary display 82. However, instead of the primary display menu 84 being displayed, the user will see a secondary display menu 96 in the secondary display 94. The secondary display menu 96 has a menu button on its left hand side, an LED button in its center, and a playback button on its right hand side that can all be actuated as previously discussed by the control members 18, 20 and 22.

Actuation of the playback button causes the screen 26 to move to a playback screen 98 as shown in FIG. 15 that has a playback menu 100. The playback menu 100 includes an exit button on the left, a selection button in the center, and an edit button on the right hand side. The screen 26 of the playback screen 98 does not show a live view from the video camera 4 but instead shows a series of file folders that each have an individual name. These folders are organized to include photographs and video of specific projects unique to that folder. For example, one of the folders may include video and photographs of timing belts for different vehicles, while another one of the photographs may include video and photographs of alternators for different vehicles. Actuation of the selection button of the playback menu causes a highlighted folder to no longer be highlighted such that the next folder in turn is then highlighted. The user can select the desired project folder by first highlighting it with the selection button by turning wheel 20 and then selecting it by pulling the trigger 18. This will cause the screen 26 to move to a project folder screen 102 for the specific folder previously selected, as shown in FIG. 16. The project folder screen 102 has an exit button, a selection button, and a delete button. The exit button causes the screen to be sent back to the playback screen 98 in FIG. 15. The selection button causes a highlighting change to be made between the photos and videos folder on the screen 26. Selection of the delete button gives the user the option to delete all of the files in the photos folder, or all of the files in the videos folder of the project folder screen 102.

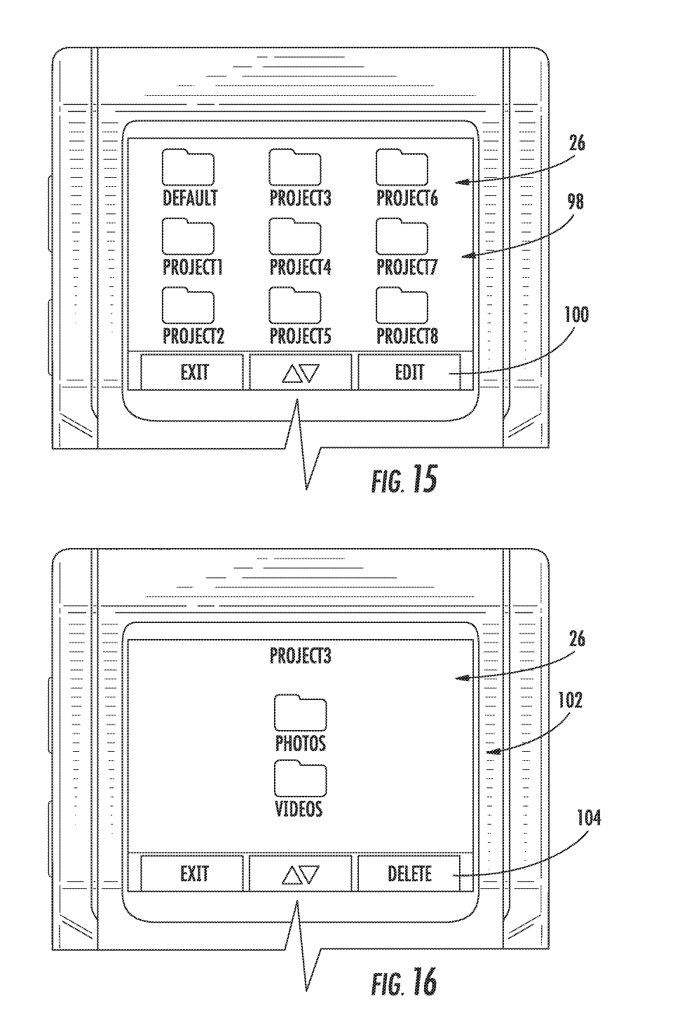

The user can select the photos folder of the project folder screen 102 by first highlighting it using the selection button of the project folder menu 104 and then by clicking the trigger 18. These commands will cause the screen 26 to move to a photograph screen 106 as shown in FIG. 17. The photograph screen 106 includes one or more photographs that were taken with the video camera 4 by clicking the trigger 18, by actuating the save button from the freeze menu 86, or by other means that cause a photograph to be stored in the apparatus 2. The various photographs can have a name assigned to them and a date that they were taken so that a user can quickly identify the photographs. The photograph screen 106 includes a photograph screen menu 108 that has an exit button, a selection button, and a delete button. The exit button causes the screen 26 to exit back to the project folder screen 102 in FIG. 16. Actuation of the delete button causes the highlighted photograph to be deleted. If the user pulls the trigger 18, the highlighted photograph will be selected and the screen 26 will then move to a saved photograph screen 110 as shown in FIG. 18.

The selected photograph will be enlarged from the photograph screen 106 to fill the entire screen 26 in the saved photograph screen 110, except for the saved photograph menu 112, to allow the user to more easily view the detail of the saved photograph. Information tagged onto the saved photograph is displayed in the upper right hand corner of the saved photograph screen 110 such as the date of the photograph and the time it was saved or taken, the project folder into which it is saved, the operator that saved the saved photograph, and the name of the photograph. The saved photograph menu 112 has an exit button that causes exiting back to the photograph screen 106 in FIG. 17. Actuation of the freeze button of the saved photograph menu 112 causes the photograph in the saved photograph screen 110 to be set as the freeze photograph 92 for use in the toggle comparison as previously described. If the user actuates the selection button of the saved photograph menu 112 the photograph displayed in the saved photograph screen 110 will be substituted with the next one in line in the project folder into which the photograph is located. The user can quickly switch between saved photographs in the saved photograph screen 110 in this manner.

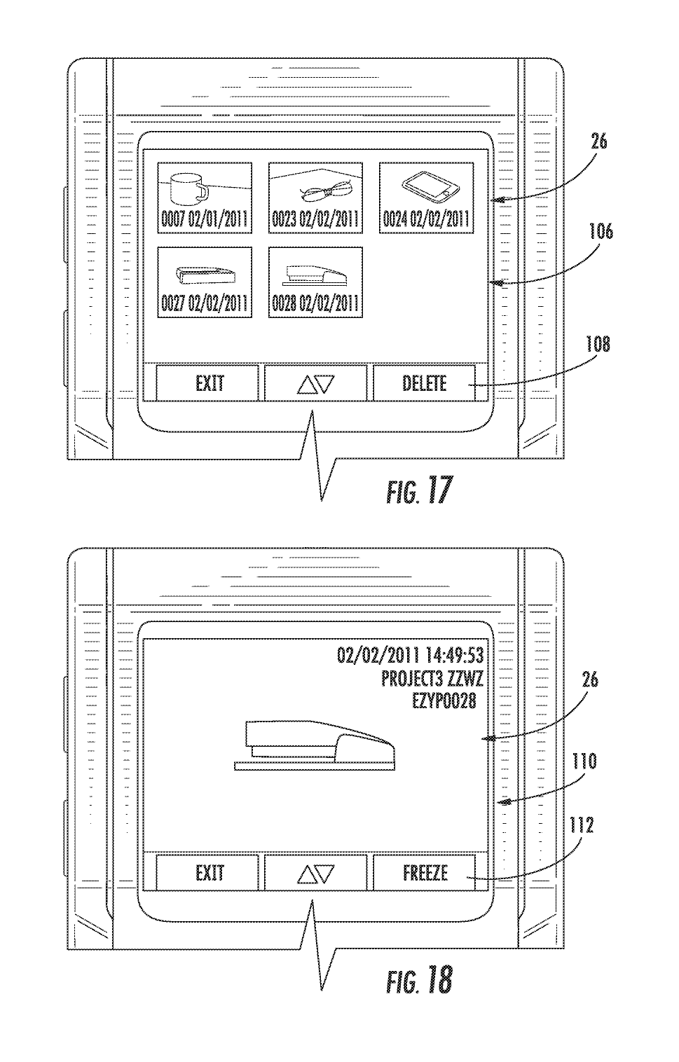

Turning back now to the playback screen 98 in FIG. 15, the playback menu 100 has an edit button that can be selected upon pressing the second key 24. This will cause the highlighted folder in the playback screen 98 to be edited such that the screen 26 will move to an edit screen 114 as shown in FIG. 19. Information associated with the particular folder can be edited in the edit screen 114. The edit screen 114 has an edit menu 116 at its bottom that includes a exit button, a selection button, and a help button. Actuation of the help button causes a help screen to be displayed on the screen 26 that instructs the user as to how the edit screen 114 can be navigated and manipulated in order to change information associated with the folder in question. Actuation of the selection button upon movement of the wheel 20 causes a highlighted item in the left hand menu of the edit screen 114 to be unselected and the next item in order to be selected. Forward movement of the wheel 20 causes the next vertically positioned item to be highlighted, while backward movement of the wheel 20 causes the next vertically lower item to be highlighted. Continued movement of the wheel 20 causes the highlighted selection to move up or down the list so as to then flip either upwards or downwards once it reaches the bottom or top.

The user may move the wheel 20 so that the “Title” item is highlighted. The user can then click the trigger 18 to cause the title of the folder to be added, edited, or deleted. Here, the box in the right hand column is highlighted and rotation of the wheel 20 causes a sequence of alpha numeric symbols to be displayed. Once the desired alpha numeric symbol is located, the user may click the trigger 18 to select such symbol and may then continue to add or delete symbols as desired. Once the appropriate title has been registered by the user, her or she can turn the wheel 18 until a designated return symbol is highlighted and then click the trigger 18. This causes the present word or name in the right hand box next to the “title” item to be entered and the highlighting moves back to the left hand column. The user can then actuate the wheel 20 up and down to select and modify the “Customer”, “Equipment”, or “Operator” items as desired. The “AutoStore” and “Embed” items are not names that can be modified by the user but instead their actuation gives the user a choice of “yes” or “no” that can be selected in order to turn these functions on or off. “Autostore” causes photos to be automatically stored in the designated folder, and “Embed” causes data associated with the folder to be automatically inserted into the photograph when taken. This data may be the title, customer, equipment, and operator. The date and time may always automatically be embedded into the photograph when taken regardless of the setting of the “Embed” option. The user may select the Exit button from the edit menu 116 in order to return the screen 26 back to the playback screen 98 in FIG. 15.

Returning now back to the secondary display 94 in FIG. 14, the LED button of the secondary display menu 96 will now be explained. The LED button is actuated upon the forward movement of the wheel 20. Such movement will cause an LED light at the end of the video camera 4 to turn on in order to provide illumination to the object in question being viewed. Continued forward movement of the wheel 20 can increase the intensity of the emitted light. Likewise, backward movement of the wheel 20 may cause the LED to be dimmed so that less light is emitted. Continued backward movement of the wheel 20 will cause the LED to be turned off. The LED illumination may be adjustable in that four LED lights can be present and each may be turned on per actuation of the wheel 20 to cause a different amount of light to be generated. The LEDs used can be ultra-violet LEDs for use in identifying leakage of fluids enhanced for UV fluorescence.

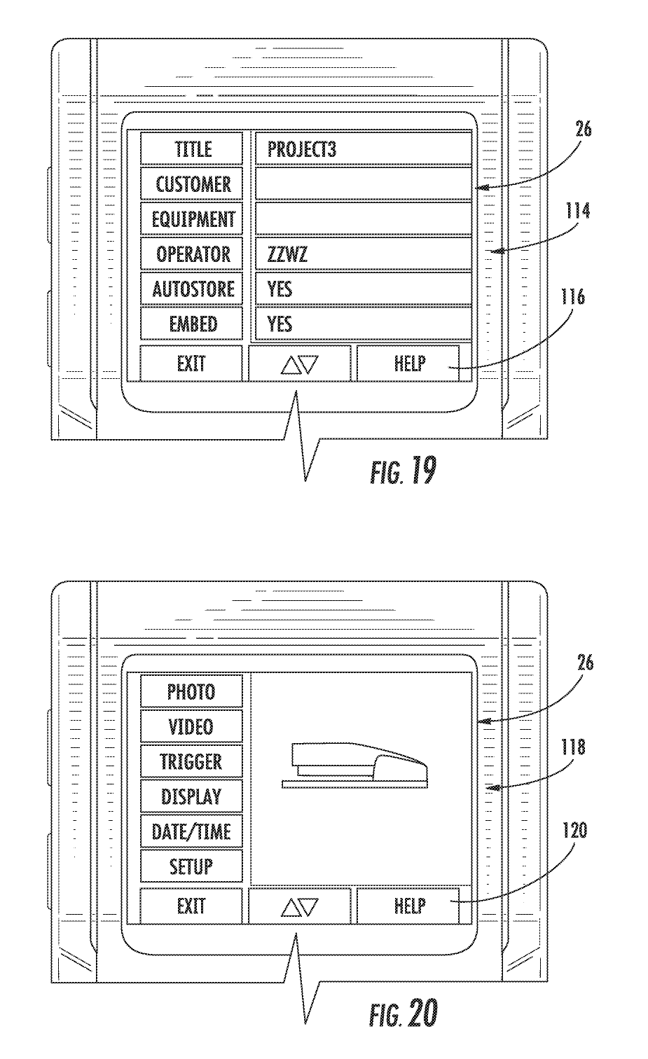

The secondary display menu 96 includes a menu button that can be actuated by the user upon clicking the first key 22. Doing so causes a configuration menu screen 118 to be displayed as illustrated in FIG. 20. This screen 118 includes a live view from the video camera 4 and a vertical list of items on the left hand side. A configuration menu 120 is included on the bottom of the configuration menu screen 118 and is actuated by the control members 20, 22 and 24. The configuration menu 120 has a help button on the right hand side that upon actuation by the second key 24 causes a help message to be displayed over the live view from the video camera 4 that instructs the user as to the proper execution of commands for the particular task the user is attempting. The configuration menu 120 also includes a selection button at its center operated by wheel 20 that causes the items in the vertical list to be highlighted. An exit button is present that returns the user to the primary display 82.

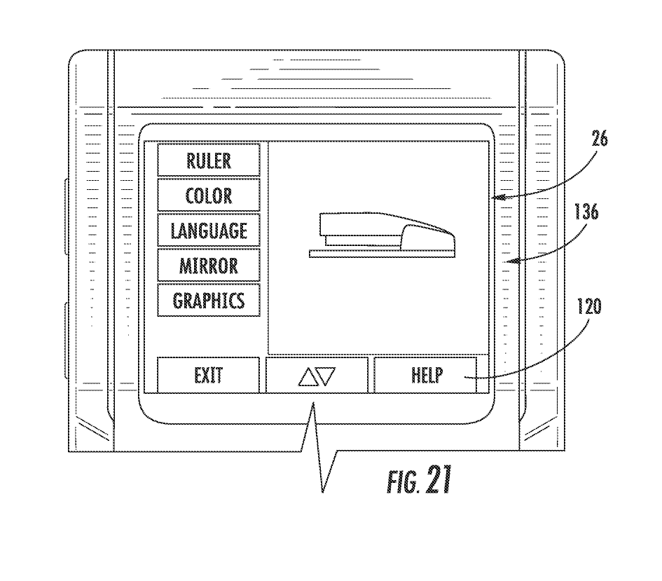

The user may highlight the “Photo” item on the configuration menu screen 118 and pull the trigger 18. This causes the screen 26 to move to a photo menu screen 122 as shown in FIG. 22. The photo menu screen 122 allows the user to change properties associated with the photographs taken by the video camera 4. A live view of the video camera 4 is shown along with three items arranged in a vertical formation by the names of “Brightness”, “Contrast”, and “Image Size.” Also, a photo menu 124 having a help button, a selection button, and an exit button is included. The help button will cause a help feature to be displayed, and the exit button causes the screen 26 to return back to the previous configuration menu screen 118, and the selection button changes the highlighted item in the vertical column.

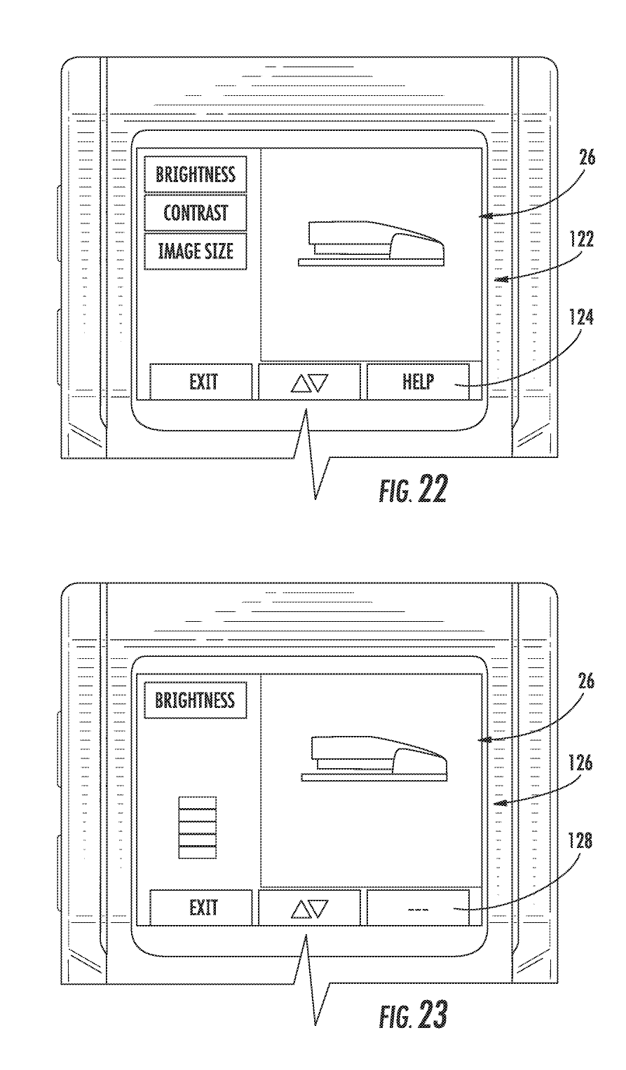

Highlighting the “Brightness” item and pulling the trigger 18 causes the screen 26 to move to a brightness selection screen 126 as shown in FIG. 23. The brightness selection screen 126 has a live view of the video camera 4, a brightness meter on the left hand side, and a brightness menu 128 on its bottom. The brightness menu 128 only has 2 buttons that can be actuated by the user. In this regard, the right hand button is blank and hence pressing of the second key 24 functions to do nothing. The exit button will cause the screen 26 to jump back to the photo menu screen 122 of FIG. 22. The selection button will cause the meter on the left hand side to move up or down hence increasing or decreasing the brightness of the photo that is taken. Once the desired brightness is set, the user can click the first key 22 to actuate the exit button and cause the set brightness to be saved. Doing so again causes the screen 26 to move back to the photo menu screen 122 of FIG. 22.

The photo menu screen 122 also includes a “Contrast” item that can be selected in order to allow the amount of contrast to be adjusted by the user in a manner similar to that previously discussed with respect to the brightness. Further, the photo menu screen 122 includes an “Image Size” item that can be selected in order to provide the user with a number of options as to the size of the photo that is taken. The user can select between an image size of 1600×1200, 800×600, or 320×240, for example. Clicking on the exit button from the photo menu 124 will cause the screen 26 to move back to the configuration menu screen 118 as illustrated in FIG. 20.

The various items in the vertical column of the configuration menu screen 118 will now be described. Selection of particular items will cause certain screens to be displayed on the screen 26 that can be manipulated in manners as previously described in order to achieve desired settings. Selection of the “video” item will allow the user to modify settings associated with the video that is captured by the video camera 4. These settings may be a video mode that is variable or fixed, and a video time that is the length of time video is taken such as 10 seconds, 20 seconds, or 30 seconds. Also, the video size may be selected that allows one to change the size of the video, for example 720×480, 640×480, or 320×240. Also, the quality of the video may be selected that allows one to set the video at 30 fps, 20 fps, or 15 fps. Additionally, an audio item can be actuated the allows one to set whether audio on the video is recorded or not.

Referring now back to the configuration menu screen 118, an item labeled “Trigger” will now be described. This item can be selected in order to affect the behavior of the trigger 18. First, the mode of the trigger 18 can be selected so as to be either normal, burst, motion, or time lapse. Normal mode of the trigger 18 has the effect of causing the pulling of the trigger 18 to cause a picture to be taken. If the trigger 18 is set into burst mode a series or burst of photographs are taken once the trigger 18 is pulled. The burst mode may be further defined by the user in that the number of photographs that are taken can be set. Also, the speed of the photographs that are taken can be set between high, medium, or low. The taking of a burst of high speed photos may allow for the capture of an event that may be missed by a single shot. The delay of the burst may be set in certain embodiments in which the time between photos is set by the user.

If the trigger 18 is set into motion mode, a picture will be taken once the apparatus 2 detects movement. The motion mode may be further defined in that the user can be asked whether he or she wants motion mode for the taking of pictures or video. Additionally, a sensitivity setting can be selected between low, medium, and high so that actuation will be performed when the set level amount of motion is in fact noticed by the apparatus. The motion can be detected by the memory mean 14 noting various changes on the feed from the video camera 4. An audio alert feature may be present in that once the apparatus 2 detects motion and begins to record or take a picture, an audible noise can be made. This may allow the user to determine a cause and effect.

Trigger 18 can also be set into a time lapse mode. Upon the selection of time lapse mode, the user can be asked whether he or she wants to use the time lapse mode for photograph taking or video taking. Next, the user may be able to select the interval of time lapse. For example, the user can set the amount of seconds that elapse between the taking of each picture. Finally, the user may be able to set the duration of time lapse which may be the amount of time that pictures are taken. For example, if the user sets an interval of 5 seconds and a duration of 20 seconds, actuation of the trigger 18 will cause a picture to be taken every 5 seconds for a total of 20 seconds at which time no further pictures will be taken.

With reference now back to the configuration menu 120, the “display” item will now be described. Actuation of this item causes the screen 26 to change to a display screen 136 as shown in FIG. 21. The display screen 136 includes a vertical list of items that are associated with the display of the video camera 4. The display screen 136 allows for the modification of a ruler, color, language, mirror, or graphics of the display. The ruler can be turned on or off by the user. With reference back to FIG. 11, the primary display 82 shows a ruler 130 thereon that assists the user in ascertaining the size of the stapler that is being viewed by the video camera 4. If the user turns the ruler off, the ruler 130 in the primary display 82 will be removed.

If the user selects the “color” item, the screen 26 will move to a color selection screen 132 as illustrated in FIG. 24. The color selection screen 132 includes a live view as seen from the video camera 4, and a series of items arranged in a vertical list that can be selected such as enhanced, basic, or greyscale. The color selection screen 132 also has a color selection menu 134 at its bottom in which the right hand button is non-functional, the center button allows for the selection of the item from the vertical list, and the left hand button is an exit button that causes the screen 26 to jump back to the previous display. The color of the display can be highlighted and then selected upon pulling the trigger 18. Doing so causes the color of the live display in the color selection screen 132 to be changed as selected. The user can then know whether he or she wants to use the selected color or to select a different color.

With respect to the remaining “display” items, the user can change the language that the apparatus 2 displays between either English or Spanish. In other exemplary embodiments, the language can be switched to French, German, Dutch, Portuguese, Italian, Japanese, Russian, or Chinese. Further, the user can use the “mirror” item to cause the orientation of the displayed live feed from the video camera 4, or a photograph if it is selected, to be flipped in either the horizontal direction, the vertical direction, or both in the horizontal and vertical directions. This functionality may be useful when the video camera 4 is positioned inside of a hard to reach place and the image displayed on the screen 26 is upside down or rotated or otherwise out of proper orientation. The user may adjust the orientation of the display so that it more closely matches the orientation of the freeze photograph 92, or so that the live display or resulting photographs are in more desirable pose. Additionally, a graphics item can be adjusted so that the amount of graphics are reduced or eliminated when using the apparatus 2. For example, if the graphics are turned off, the primary display 82 will not show the primary display menu 84. This will allow a larger display image to be seen of the view captured by the video camera 4. However, once the user clicks a control member, for example the wheel 20, the primary display menu 84 will return so that the user can access its functionality. The items, buttons, keys, and menus, by whatever name, that are displayed on the screen 26 and that can be actuated are referred to as soft keys.

With reference now to the display screen 136 in FIG. 21, it can be seen that there are five items in the vertical column on the left hand side. The items can be selected upon turning the wheel 20 so that the desired item is highlighted, and then by pulling the trigger 18 to select the highlighted item. However, additional items besides the five shown may be provided to the user. Here, the user can turn the wheel 20 so that the highlighted item is then above the vertically highest item, or below the vertically lowest item. This action will cause the five items shown in FIG. 21 to disappear and then to be replaced by six different items. The user can sequence back to the five items shown in FIG. 21 from the six new items by continued rotation of the wheel 20 so that the highlighted item is above or below the highest or lowest item in the list as previously described. In some embodiments, when the user clicks the “display” item on the configuration menu screen 118 of FIG. 20, the screen 26 goes first to the display screen 136 that has these six new items, and not the five items shown in FIG. 21.

The six new items in the display screen 136 may labeled “Brightness”, “Contrast”, “Thumbnail”, “Beep”, “Volume”, and “TV Format.” Actuation of the Brightness button presents the user with a scale that can be adjusted up or down with the selection key upon turning wheel 20 so that the brightness of the screen 26 is increased or diminished. The Contrast button works the same way, only it affects the contrast of the screen and not its brightness. The Thumbnail button gives the user a choice of either thumbnails on or thumbnails off. If the user chooses thumbnails off, the thumbnails such as those shown in FIG. 17 will not be shown and instead the photographs will be described by their name, date, time, and/or size. The Beep item gives the user a choice of having a beep sound every time one of the control members 18, 20, 22, or 24 is actuated. Such an arrangement may assist the user with operation when the user is unable to see the screen 26. Alternatively, the user can set a beep to occur only when a picture is taken, or the user can turn the beeps off so that beeps are never emitted. The volume item allows the user to set the volume of sound emitted by the apparatus 2. The TV Format item may allow the user to set the format of transmission between either PAL or NTSC.

With reference back to the configuration menu screen 118, the Date/Time item will now be described. This item allows the user to set the proper date and time on the apparatus 2, and for the desired month/day/year format to be employed. Also, the user can select whether a time stamp is or is not to be added or included with each photograph.

The last item included in the configuration menu screen 118 is the setup item that can be selected to cause screen 26 to change so that six items are shown in the left hand vertical column. The six items may be “Memory”, “Password”, USB Mode”, “Default”, “Auto Off”, and “About”. The memory item allows the user to check the amount of free RAM in the memory means 14 and to check the amount of free memory on an SD card if inserted into the SD card slot 40. The memory item also gives the user the option of copying photographs stored on the memory means 14 to the SD card, the option of formatting the SD card in the SD card slot 40, and the option of clearing the memory of the memory means 14 so that the photographs stored on the memory means 14, along with information associated with each project folder, are erased. The Password item allows the user to enable password protection for accessing a menu such as the menu items in the configuration menu screen 118, or to enable password protection for accessing the entire apparatus 2 such that upon start up after hitting the power button 60 a password is required to move forward from this point.

The USB Mode effects the default behavior of the apparatus 2 when connected to a personal computer. The user may be able to choose between either “memory” or “camera” in the USB Mode so that if memory is selected, connection to a PC causes items in the memory to be displayed on the PC, while if camera is selected connection to a PC causes the feed from the video camera 4 to instead be displayed. The apparatus 2 can be connected to a PC and used as a web cam in certain arrangements. The PC connected to the apparatus 2 can be used to view the image from the video camera 4 and to record this footage and take pictures. The “default” item gives the user the option of returning the apparatus 2 to its factory provided default settings. The “Auto Off” item gives the user the option of setting a time limit at which to turn off the apparatus 2 if the unit is idle for the entire time of the time limit. The time limit may be 15 minutes in some exemplary embodiments. The user may likewise set the apparatus 2 with the Auto Off item so that it never turns off no matter how long it is idle. The “About” item provides information about the apparatus such as the current version of software.

The user can cycle through the six items by turning the wheel 20 and may make the appropriate selection by pulling the trigger 18. If the user turns the wheel 20 so that the highlighted item goes above or below the six items, the six items are replaced with two items that are an “Upgrade” item and a “Demo mode” item. The Upgrade item allows the user to upgrade their apparatus to include additional functionality. The upgrade item may be used when the apparatus 2 is connected to a PC so that software of the memory means 14 is upgraded or additional features are added to the apparatus. The Demo mode item allows the user to enter a demo mode that may display a video that demonstrates different functionality of the apparatus 2 to the user.

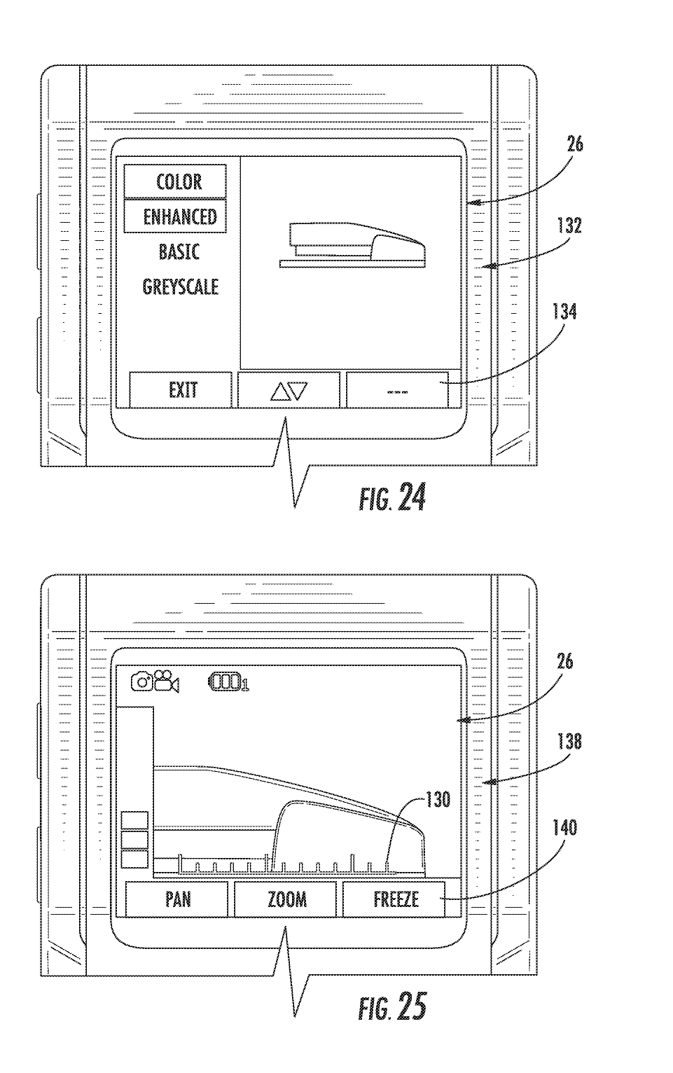

Once the user makes the desired changes in the options accessible through the configuration menu screen 118, clicking on the exit button in the configuration menu 120 causes the screen 26 to be sent back to the primary display 82. Additionally, if the screen 26 is on the secondary display 94 and the user does not actuate one of the buttons on the secondary display menu 96, the screen 26 will jump back to the primary display 82 after some amount of time, for example 5 seconds, has elapsed. The zoom feature of the apparatus 2 may be accessed by the user turning the wheel 20 forward to actuate the zoom button of the primary display menu 84. Doing so will cause the screen 26 to change to a zoom screen 138 as shown in FIG. 25. The zoom screen 138 has a level indicator on the left hand side that indicates the amount of zoom applied to the live display from the video camera 4 that is shown in the zoom screen 138.

The digital zoom may be up to an eight times digital zoom in some embodiments. Each forward click of the wheel 20 causes the level indicator on the left hand side to increase one notch which in turn causes the display to be further zoomed in. Continued forward rotation of the wheel 20 will cause all of the bars of the level indicator to light and the display will be at its maximum zoom length. The scaling of the ruler 130, if present, will likewise change to stay in proportion to the zoomed in amount of the display. Backwards rotation of the wheel 20 causes a decrease in the amount of bars and likewise causes the display to zoom out. If the user continues to rotate the wheel 20 back so that zero bars are present on the level indicator, the screen 26 will jump out of the zoom screen 138 back to the primary display 82 of FIG. 11. The zoom feature can be used to zoom into both photographs and video that were previously recorded in addition to live feed images from the video camera 4.

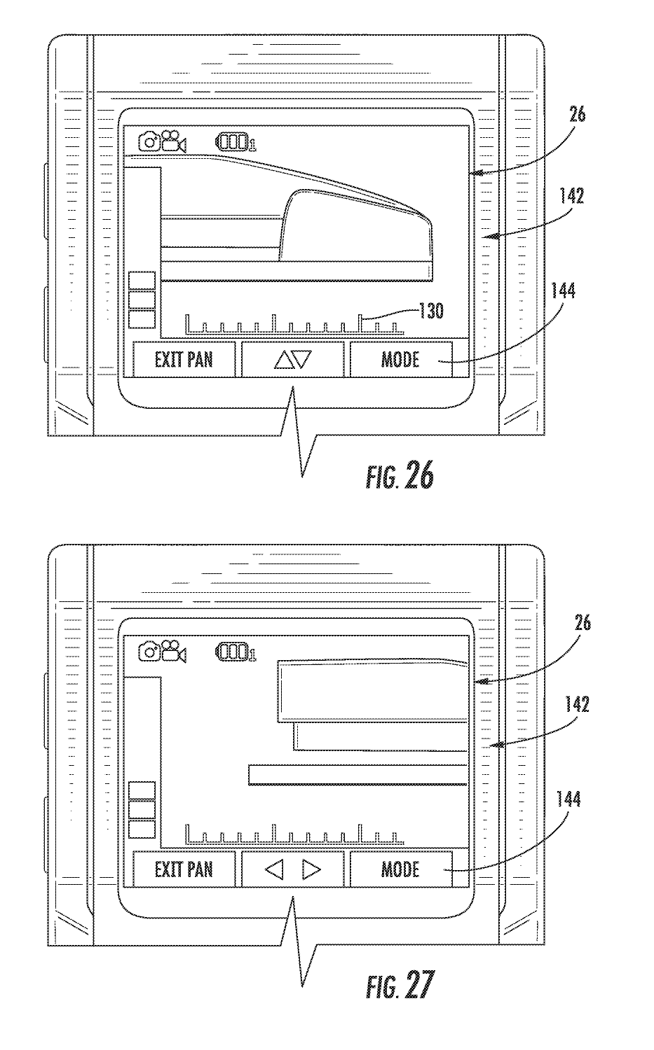

The zoom menu 140 has a freeze button that if actuated causes the screen 26 to move to the freeze photograph 92 of FIG. 12 in which the display shown in the zoom screen 138 is designated the freeze photograph 92 and a snowflake or other freeze icon 88 is assigned. The user can then toggle back and forth between the freeze photograph 92 and the live view as previously discussed. The zoom menu 140 also includes a pan button that can be actuated by clicking the first key 22. This causes the screen 26 to move to a pan screen 142 as shown in FIG. 26. The pan screen 142 has a level indicator on its left hand side and a pan menu 144 at its bottom. The pan menu 144 includes an exit pan selection that if actuated by pressing the first key 22 causes the display to move back to the zoom screen 138. The pan menu 144 also has a selection button at its center that is actuated by movement of the wheel 20. Forward movement of wheel 20 causes the display in the pan screen 142 to move upwards so that the user can see portions of the image captured by the video camera 4 that are above that shown in the pan screen 142 before such wheel 20 movement. Backwards movement of the wheel 20 causes the display to pan downwards so that portions of the image captured by the video camera 4 are moved into view on the pan screen 142.

Use of the pan feature does not cause the video camera 4 to move. The video camera 4 stays in the same place when the pan feature is utilized. Instead, the video camera 4 captures an image but only displays a smaller amount of that image on the screen 26. When the pan feature is utilized, the upper and lower portions of the captured image are shown as well. However, it is to be understood that in other exemplary embodiments of the apparatus 2, the video camera 4 may be made moveable so that the pan feature actually results in the movement of the video camera 4 and the capture of additional portions of the image not all ready previously captured.

In accordance with other exemplary embodiments, the pan feature can only be used once the image has been zoomed some degree. Here, the live image and photographs taken by the video camera are not cropped off or otherwise reduced in size but instead the full image or photograph is displayed on the screen 26. Since all of the portions of the image or photograph are displayed, the pan feature will not work. However, once the image or photograph is zoomed in some degree, additional portions of the image can be panned onto.

The pan menu 144 has a mode button on its right hand side that can be actuated through clicking the second key 24. Doing so causes the pan menu 144 to change as illustrated in FIG. 27. The only difference between the pan screen 142 of FIG. 26 and FIG. 27 is that the selection button in the pan menu 144 of FIG. 27 has its arrows pointing to the right and left. In this regard, when the pan screen 142 is displayed as that shown in FIG. 27, the wheel 20 can be moved forward so that the image displayed is moved to the right to reveal images captured by the video camera 4 not previously shown. Likewise, backward movement of the wheel 20 causes the display screen to pan to the left so that images to the left of the initial displayed image can be seen. The left to right pan can be accomplished in the same manner as previously discussed with respect to the up and down pan such that initially captured, but previously non-displayed, images are now shown. Additionally or alternatively, the video camera 4 may be made moveable in order to achieve the pan effect. The user can exit the pan screen 142 by actuating the exit pan button of the pan menu 144 to return back to the zoom screen 138. The pan feature may function when the displayed image is zoomed in, or not zoomed in.

From the primary display 82 shown in FIG. 11, the user can click the trigger 18 in order to take a photograph as shown in the primary display 82. Doing so may change the primary display menu 84 so that an exit button is on the left hand side, a zoom button is in the center, and so that a dictate button is on the right hand side. If the user then actuates the exit button, the primary display menu 84 as shown in FIG. 11 returns but the photograph taken is still saved to the designated folder of the memory means 14. If the user actuates the zoom button by turning the wheel 20, the zoom feature as previously discussed can be used. Additionally, if the zoom button is actuated the left button changes to pan, and the right button remains dictate. The pan feature can be used as previously indicated. The dictate button if actuated by the user causes the apparatus 2 to begin to record sounds made by the user. A microphone associated with the apparatus 2 can be used for this purpose. Such a microphone may be build into the handle 16, head part 36, or base part 48 of the apparatus 2. Alternatively, a microphone may be connected to the AV in port 70 to capture sound made by the user.

Once a picture is taken and the dictate button is actuated, the primary display menu 84 can change to have an exit button on the left side, nothing in the center, and a stop button on the right side. The exit button will exit out of the current primary display menu 84 and back to the primary display menu 84 shown in FIG. 11 without causing any of the sound to be saved. Sound will be recorded until the stop button is actuated. Next, the primary display menu 84 will change so that an exit button is on the left side, nothing is in the center, and a play button is on the right hand side. Actuation of the play button causes the previously recorded sound to be played. When this happens, the primary display menu 84 includes an exit button on the left side, a zoom button in the center, and a dictate button on the right hand side. Actuation of the dictate button causes the previously recorded sound to be deleted and for the new sound to be recorded.

The recorded audio is linked to the picture that was taken so that the user can give certain information about the picture. When the photograph is selected, such as when a particular photograph is highlighted and selected in the photograph screen 106, the photograph is viewed on the screen 26 while at the same time the recorded sound is played for the user. A speaker can be integrally built into the handle 16, head part 36, or base part 48 of the apparatus 2. Alternatively, a speaker can be connected to the AV out port 68 to emit the recorded sound. Although described as being associated with a photograph, it is to be understood that the recorded audio message can be associated with a video as well.

The apparatus 2 can be constructed so that a user can hold the apparatus 2 by handle 16 while at the same time have access to all of the control members 18, 20, 22 and 24 with the same hand that is used to hold the apparatus 2. The wheel 20 although described as being able to be rotated to cause actuation can also be pushed in order to cause actuation instead of or in addition to being rotated. Pushing of the wheel 20 is similar to pulling the trigger 18 or pushing one of the keys 22 or 24. In some exemplary embodiments, the trigger 18 can be arranged so that if a user briefly pulls the trigger 18 a photograph is taken by the video camera 4, while if a user holds the trigger 18 in for an extended amount of time such as one second or longer instead of a photograph being taken video is recorded. The video may continue to be recorded until the user releases the trigger 18. Such a design may allow for the recording of objects of interest without the need to select any menu options or change recording type. Other arrangements of the apparatus 2 are also possible. For example, a fixed length video recording option may be present. Here, the user will set the length of the desired video recording. Upon actuation of the trigger 18, video from the video camera 4 will record for the pre-defined duration and then automatically stop without the need to press the trigger 18 or any other key of the apparatus 2.

Although not shown in the drawings, the apparatus 2 may include an accessory pack that can be a collection of mirrors, magnets and hooks. These items can be connected to the video camera 4 to enable viewing at 90 degrees for the recovery of metal items, or to hook or manipulate objects such as cables in order to save time and effort when accessing hard to reach locations. A gripper can be present on the end of the video camera 4 or cable 8 in order to grab and manipulate objects. Additional accessory items can be affixed to the video camera 4 or used in conjunction therewith for specific applications such as underwater use of the apparatus 2 or for inspection of a ceiling.

Although the apparatus 2 has been described herein as taking a picture or pictures, it is to be understood that the apparatus 2 can be configured for the taking of video. As such, the various commands and settings described can be used to affect the taking of video as well as pictures. Applicant has used the terms picture or photograph for sake of simplicity and it is to be understood that the terms picture and photograph are broad enough to include video as well with respect to certain commands and settings. As such, when described as taking a picture, it is to be understood that instead of a picture video could be taken and saved as previously discussed. Also as used herein, the term image is broad enough to include a photograph, a video, or a combination of photos and video.

The apparatus 2 can be held with a single hand of the user such that the user's hand 30 grasps the handle 16 and the entire menu selection of the memory means 14 can be selected and actuated by the thumb 34 of the user upon clicking the control members 20, 22 and 24 and turning the wheel 20. The clicking of the wheel 20, that is pressing onto the wheel 20 and not turning, can be used to substitute for the actuation of the trigger 18 so that the trigger 18 is not needed. In yet other embodiments, the forefinger 32 of the user may be used to make the selections upon the pulling of the trigger 18.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

What is claimed:

1. An apparatus for use in providing a view of an area, comprising:
a handle configured for being grasped by a user;
a screen for use in displaying a live image;
a plurality of control members capable of being actuated by the user in order to make selections; and
a freeze image capable of being displayed on the screen, wherein actuation of a single one of the control members causes the screen to toggle between the live image and the freeze image such that the live image or the freeze image that is currently displayed on the screen is substituted with the other one of the live image or the freeze image that was not currently displayed.

2. The apparatus as set forth in claim 1, further comprising:
a memory means configured for causing the live image to be displayed onto the screen; and
a video camera attached to a cable that is in communication with the memory means such that the live image captured by the video camera is transferred to the memory means that in turn causes the live image to be displayed onto the screen.

3. The apparatus as set forth in claim 1, wherein a first one of the control members is a trigger positioned so as to be actuated by a forefinger of a hand of the user when the user grasps the handle, wherein a second one of the control members is a wheel positioned so as to be actuated by a thumb of the hand of the user when the user grasps the handle, wherein turning of the wheel causes the toggle between the live image and the freeze image, wherein a third one of the control members is a first key positioned so as to be actuated by the thumb of the hand of the user when the user grasps the handle, wherein a fourth one of the control members is a second key positioned so as to be actuated by the thumb of the hand of the user when the user grasps the handle.

4. The apparatus as set forth in claim 3, further comprising a primary display that is displayed on the screen that has a primary display menu, wherein the primary display menu has an options button selectable upon actuation of the first key, wherein the primary display menu has a zoom button selectable upon actuation of the wheel, and wherein the primary display menu has a freeze button selectable upon actuation of the second key, wherein the live image is displayed on the screen when the primary display is displayed on the screen, and wherein selection of the freeze button causes the live image that is displayed onto the screen to be set as the freeze image.

5. The apparatus as set forth in claim 1, wherein when the freeze image is displayed on the screen a freeze icon is displayed on the screen with the freeze image, and wherein when the freeze image is displayed on the screen a freeze menu is also displayed on the screen that has an exit button, a toggle button, and a save button, wherein actuation of the save button causes the freeze image to be saved to a project folder.

6. The apparatus as set forth in claim 1, wherein one of the selections is an image capture configuration in which a capture of an image can be set in a normal mode, a photo burst mode, a motion detection mode, or a time lapse mode, wherein in the normal mode the image is captured upon the actuation of one of the control members, wherein in the photo burst mode a plurality of the images are captured upon actuation of one of the control members, wherein in the motion detection mode the image is captured upon the detection of motion after actuation of one of the control members, wherein in the time lapse mode a plurality of the images are captured upon the passage of a set amount of times after actuation of one of the control members.

7. The apparatus as set forth in claim 1, wherein an image is capable of being captured from the live image, and wherein on the screen the user is presented with an option of recording sound from the user that is associated with the image that is captured.

8. The apparatus as set forth in claim 1, wherein the freeze image is a photo.

9. The apparatus as set forth in claim 1, wherein the freeze image is a video.

10. An apparatus for use in providing a view of an area, comprising:
a handle configured for being grasped by a user;
a screen for use in displaying a live image;
a head part that extends from the handle, wherein the screen is located at the head part;
a plurality of control members capable of being actuated by the user in order to make selections; and
a playback screen capable of being displayed on the screen, wherein the playback screen has a playback menu with a selection button and an edit button, wherein the playback screen has a plurality of project folders into which captured images are capable of being stored such that different project folders are capable of having different captured images stored therein.

11. The apparatus as set forth in claim 10, further comprising an edit screen capable of being displayed on the screen when the edit button of the playback menu is actuated, wherein the edit screen enables the user to associate a title to a particular folder, a customer identification to the particular folder, an equipment identification to the particular folder, an operator identification to the particular folder, wherein the edit screen enables the user to set whether one of the captured images upon being captured from the live image is stored in the particular folder, and wherein the edit screen enables the user to set whether certain information is embedded into the one of the captured images upon being captured from the live image.

12. The apparatus as set forth claim 10, further comprising:
a project folder screen that is displayed upon the selection of a particular project folder from the playback screen, wherein the project folder has a photos sub-folder and a videos sub-folder that are each capable of being selected;
a photos screen that is displayed upon the selection of the photos sub-folder of the project folder screen, wherein the photos screen displays some of the captured images that are photos; and
a saved photograph screen that is displayed upon the selection of one of the captured photos from the photos screen, wherein the selected one of the captured photos is displayed on the photos screen, wherein a saved photograph menu is displayed on the saved photograph screen that has a freeze button that is capable of being selected by the user in order to designate the selected one of the captured photos that is displayed on the photos screen a freeze photograph.

13. The apparatus as set forth in claim 10, further comprising a pan screen capable of being displayed on the screen, wherein the live image is displayed on the pan screen, wherein the pan screen has a pan menu with a selection button that when actuated causes the live image to pan on the pan screen such that a portion of the live image not displayed on the pan screen is then displayed on the pan screen.

14. The apparatus as set forth in claim 13, further comprising:
a memory means configured for causing the live image to be displayed onto the screen;
a video camera attached to a cable that is in communication with the memory means such that the live image captured by the video camera is transferred to the memory means that in turn causes the live image to be displayed onto the screen; and
a zoom screen capable of being displayed on the screen, wherein the live image is displayed on the zoom screen and is zoomed in when displayed on the zoom screen, wherein the zoom screen has a zoom menu that has a pan button that when actuated causes the pan screen to be displayed, wherein the pan screen is incapable of being displayed unless the zoom screen is first displayed before the pan screen.

15. The apparatus as set forth in claim 10, further comprising a freeze photograph screen that displays a freeze image, wherein the freeze photograph screen has a freeze menu that has an exit button, a toggle button, and a save button, wherein the freeze photograph screen has a freeze icon that is displayed in order to designate the freeze image, wherein actuation of the save button causes the freeze image to be stored in one of the project folders, wherein actuation of the toggle button causes the freeze image to be removed and replaced with the live image.

16. The apparatus as set forth in claim 15, wherein the freeze image is a video.

17. An apparatus for use in providing a view of an area, comprising:
a handle configured for being grasped by a user;
a screen for use in displaying a live image;
a video camera attached to a cable to capture the live image;
a plurality of control members capable of being actuated by the user; and
a plurality of soft keys capable of being displayed onto the screen that are capable of being actuated upon actuation of the control members, wherein the control members are positioned on the handle such that all of the control members are capable of being actuated by the same hand of the user that is used to grasp the handle when the hand grasps the handle, wherein every soft key that is ever displayed on the screen is capable of being actuated by the control members by the same hand of the user that is used to grasp the handle while the handle is grasped.

18. The apparatus as set forth in claim 17, further comprising:
a freeze image capable of being displayed on the screen, wherein actuation of a single one of the control members causes the screen to toggle between the live image and the freeze image such that the live image or the freeze image that is currently displayed on the screen is substituted with the other one of the live image or the freeze image that was not currently displayed;
a playback screen capable of being displayed on the screen, wherein the playback screen has a playback menu with a selection button and an edit button, wherein the playback screen has a plurality of project folders into which captured images are capable of being stored such that different project folders are capable of having different captured images stored therein; and
wherein the video camera captures the live image when motion is detected by the apparatus, wherein an audible alert is made when the live image is captured.

19. The apparatus as set forth in claim 17, wherein a first one of the control members is a trigger positioned on a lower side of the handle so as to be actuated by a forefinger of the hand of the user that grasps the handle, wherein a second one of the control members is a wheel positioned on an upper side of the handle so as to be actuated by a thumb of the hand of the user that grasps the handle, wherein a third one of the control members is a first key positioned on the upper side of the handle so as to be actuated by the thumb of the hand of the user that grasps the handle, wherein a fourth one of the control members is a second key positioned on the upper side of the handle so as to be actuated by the thumb of the hand of the user that grasps the handle, wherein the wheel is located between the first key and the second key.

20. The apparatus as set forth in claim 17, wherein the handle has a base part located on a bottom end of the handle, wherein a first one of the control members is a trigger, wherein actuation of the trigger causes the live image to be captured as a photograph, and wherein actuation of the trigger for a predetermined amount of time causes the live image to be captured as a video, and further comprising:
a stud finder located in the base part for use in locating studs in a wall of a structure; and
a magnet located in the base part for use in affixing the base part to a surface.
